(19) United States
(12) Patent Application Publication
(10) Pub. No.: US 2014/0176087 A1
(43) Pub. Date: Jun. 26, 2014

(54) ALTERNATOR WITH VOLTAGE REGULATION

(71) Applicants: Emile Mouni, L'isle D'espagnac (FR); Samuel Moser, Gond-pontouvre (FR)

(72) Inventors: Emile Mouni, L'isle D'espagnac (FR); Samuel Moser, Gond-pontouvre (FR)

(73) Assignee: MOTEURS LEROY-SOMER, Angouleme (FR)

(21) Appl. No.: 14/126,663

(22) PCT Filed: Jun. 12, 2012
(86) PCT No.: PCT/IB2012/052969

§ 371 Date: Dec. 30, 2013

(30) Foreign Application Priority Data
Jun. 15, 2011 (FR) 11 55211

(51) Int. Cl. H02P 9/10

(52) U.S. Cl. CPC H02P 9/10
USPC 322/59

(57) ABSTRACT

The present invention relates to an alternator to be electrically connected to a load, the alternator including a rotor including: a rotary field, an excitation winding, a dissipative component and a switchover system allowing the rotary field to be connected selectively to the excitation winding or to the dissipative component, and a controller controlling the switchover system so as to regulate the current in the rotary field and, in response to a reduction in the load applied to the alternator, connects the dissipative component to the rotary field to dissipate the inductive energy that has built up in the rotary field.

The subject of the present invention is a synchronous electric machine.

With the development of electric power plants using increasingly powerful alternators, it has become critically important to ensure a load take-up or a load shedding that is as fast as possible. This has resulted in increasingly sophisticated machines in terms of the electromagnetic design. Increasingly powerful computers are used in this context.

The known synchronous generators are made up of a coiled exciting generator which outputs to a diode bridge, and of a primary machine. The voltage of the exciting armature is rectified and is used to power the rotary field of the primary machine, thus making it possible to produce the voltage needed for the installation. This voltage is controlled by virtue of a voltage regulator which supplies the exciting inductor with the excitation current according to the output voltage of the primary machine. The excitation energy is supplied either by tapping the voltage from the primary machine, or from auxiliary windings placed in the notches of the primary machine or else by using a machine with permanent magnets, mounted on the same shaft as the primary machine.

It is known from U.S. Pat. No. 6,362,588 to regulate the voltage of a synchronous machine using a system delivering control signals, of non-sinusoidal form. This system is not very reliable, because it requires synchronization signals which, in the case of an exciting generator, are very rich in harmonics, inevitably leading to synchronization difficulties affecting the robustness of the solution.

It is known from U.S. Pat. No. 6,828,919 to use, in a machine comprising supra-conductors cooled using a cryogenic liquid, transmission of information by optical link.

It is possible to reduce the influence of the exciting generator in order to obtain a better dynamics for the machine as a whole.

Not very much work is required for the intrinsic structure of the machine, the work being focussed mainly on the regulation part, for which new, so-called modern control laws are used.

There is a need to further enhance the performance levels of the alternators, in particular during strong load reductions.

The invention aims to respond at least partly to this need and achieves this, according to one of its aspects, by virtue of an alternator to be electrically linked to a load, the alternator comprising:

a rotor comprising:
a rotary field,
an exciting armature,
a dissipative component, and
a switching system making it possible to selectively link the rotary field to the exciting armature and to the dissipative component, and

a controller controlling the switching system so as to regulate the current in the rotary field and, in response to a reduction in the load applied to the alternator, link the dissipative component to the rotary field to dissipate inductive energy stored in the rotary field.

The invention makes it possible, by adjusting the current in the rotary field, to ensure regulation of the output voltage of the alternator and to significantly improve the response time of the alternator on strong load reductions.

By virtue of the invention, the current in the rotary field is very quickly reduced, and the voltage overshoots on reductions in the load are also greatly reduced.

The control of the current of the rotary field makes it possible to overcome the time constant of the exciter and to obtain improved performance levels compared to the known solutions.

The dissipative component is preferably purely ohmic. In variants, the dissipative component is of any type, the invention not being limited to a particular type of dissipative component.

The controller can be incorporated in the rotor. In a variant, the controller is not incorporated in the rotor.

The rotor preferably includes a rectifier supplying, from the exciting armature, a DC bus to which the switching system is linked.

The DC bus may include a filtering capacitor, with a capacitance of less than 30 μF/kW of excitation power. By virtue of the use of the dissipative component to dissipate the energy, a filtering capacitor of very small size is used, unlike in the known power electronic structures. In a variant, the DC bus is non-filtered.

The switching system comprises switchable electronic components, such as, for example, IGBT transistors.

The switching system preferably includes an H-configuration bridge, double quadrant, outputting to the rotary field.

A current sensor may be arranged on the rotor to measure the current in the rotary field and to transmit to the controller and/or to a voltage regulator the value of the duly measured current. The current sensor may be of any kind, notably Hall effect or inductive.

A temperature sensor for the rotary field may be arranged on the rotor.

The alternator includes a stator, including an exciting inductor, which may comprise permanent magnets. In a variant, the exciting inductor is coiled.

The stator preferably includes a voltage regulator, which may be made up of a voltage regulation module and a DC current generator.

The voltage regulator of the stator preferably acts by pulse width modulation on the switchable electronic components of the switching system of the rotor.

In the case where the exciting inductor is coiled, the voltage regulator makes it possible also to supply the exciting generator of the machine with a sufficient current to ensure an overload mode of operation and at the same time avoid an excessive heating of the exciting generator. In this case, the regulation is said to be dual-function.

When the exciting inductor comprises permanent magnets, the voltage regulator can provide just a regulation function. The dimensions of this inductor can be chosen to ensure correct operation of the alternator over its entire power range.

In a variant, the voltage regulator is placed in a remote cabinet.

An alternator according to the invention may include a system for wireless transmission arranged between the controller of the rotor and the voltage regulator of the stator, making it possible to avoid the use of rings and brushes, the life of which may be limited and involving significant maintenance requirements.

The wireless transmission system may be made up of two transmission modules, one arranged on the rotor, the other on the stator, and wireless transmission channels linking said modules.

The value of the current in the rotary field, measured by the current sensor of the rotor, can be transmitted to the voltage regulator of the stator by virtue of the bidirectional wireless transmission system.

The value of the temperature of the rotary field measured by the temperature sensor of the rotor can be transmitted by the wireless transmission system to the voltage regulator. This information may be used for the purposes of monitoring the correct operation of the machine.

The information transmitted and received by the wireless transmission system can be in binary faun. The invention is not limited to a particular coding of the data.

The transmission module of the rotor and of the controller is preferably powered from the voltage of the exciting armature rectified by the rectifier. This makes it possible to have the benefit of different power supplies for the transmission module and the controller.

A control device may be present to initialize, when the alternator is started up, all the electronic components, making it possible to ensure a gradual increase in the output voltage of the primary machine. The start-up time can be adjusted according to the requirement of the machine. By virtue of this device, the voltage increase gradient can be implemented over a time interval of between 1 second and 180 seconds. This allows for a gradual start-up and a reduction in the risks of stalling of the motor driving the machine.

The controller may be arranged to control the switching system so as to regulate the current in the rotary field by pulse width modulation. The duty cycle of the pulse width modulation may be a function of the output voltage of the primary machine, and preferentially also of the value of the current in the rotary field and of the load.

The duty cycle can be calculated as a function of the output voltage by applying a suitable control law, such as, for example, a simple PID (proportional-integral-derivative) law, or a predictive control law.

The duty cycle can advantageously be a function of the value of the current in the rotary field in order to limit the latter when it is excessive.

The duty cycle of the pulse width modulation can also be a function of the temperature of the rotary field in order to reduce the current in the case of excessive temperature.

In the case of a strong reduction in the load, the controller can reduce the duty cycle of the pulse width modulation, and can link the dissipative component to the rotary field, in order to dissipate inductive energy stored in said field.

The inductive energy can be dissipated in the form of heat in the dissipative component, and a smaller portion can be stored in the filtering capacitor, when the latter is present.

Preferably, the connection of the dissipative component to the rotary field is established when the duty cycle of the pulse width modulation is zero, and ceases when this duty cycle becomes non-zero again.

The controller may comprise at least one integrated circuit.

The rectifier, the switching system and the controller can be mounted on segments, that can be metallic, and that are preferably fixed to an axial end of the exciting armature. Said segments may be crescent-shaped.

As a variant, the rectifier, the switching system and the controller can be mounted on one or more modules fixed directly onto the rotor, notably through one or more insulating supports.

Another subject of the invention, according to another of its aspects, is a method for reducing the load-shedding response time of an alternator as defined hereinabove, in which:

in response to the detection of a reduction in the load applied to the alternator, the controller acts on the switching system to link the rotary field to the dissipative component, in order to dissipate inductive energy stored in the rotary field.

The method according to the invention may permit the reversal of the voltage at the terminals of the rotary field, rapidly reducing the current in said field and thus limiting the voltage overshoot.

All the characteristics of the invention described above are valid for the method.

Moreover, upon a load impact, in response to the detection of an increase in the load applied to the alternator, the controller can advantageously adjust the duty cycle of the pulse width modulation of the switching system in order to rapidly increase the rotary field current, thus making it possible to reduce the voltage drop and improve the response time of the alternator.

The invention can be better understood from reading the following description of non-limiting examples of implementation thereof, and on studying the appended drawing, in which:

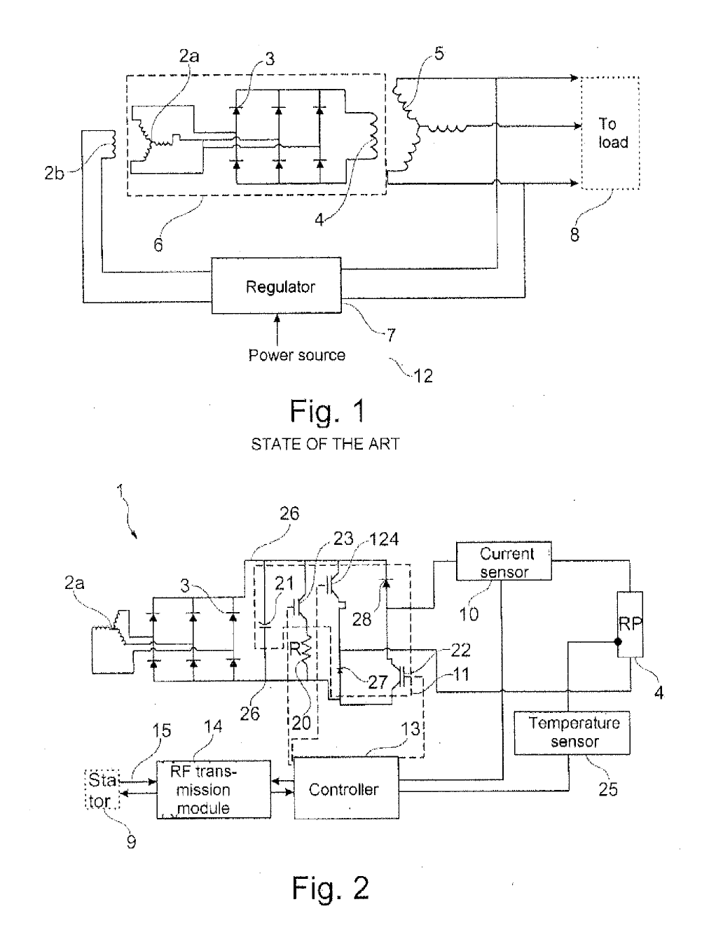

FIG. 1 is a schematic representation of an alternator according to the prior art,

FIG. 2 is a schematic representation of an alternator according to the invention,

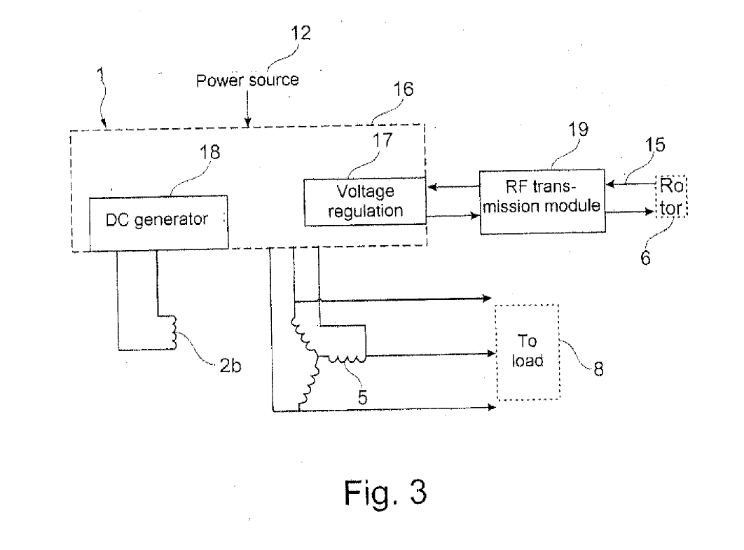

FIG. 3 is a schematic and partial representation of an alternator according to the invention,

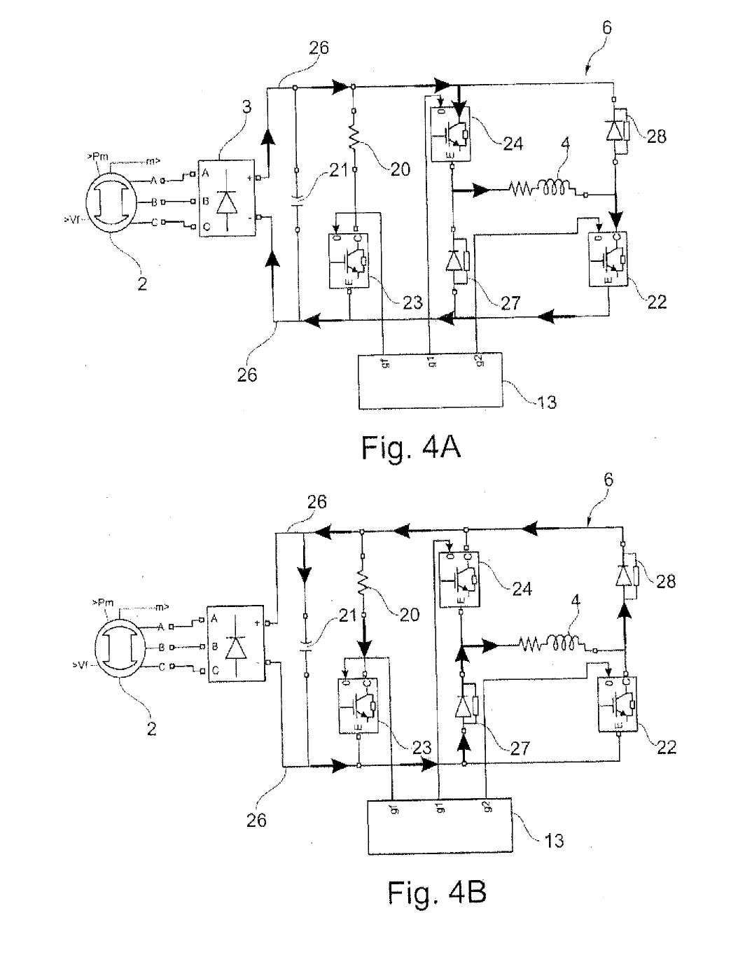

FIG. 4A illustrates the operation of the alternator according to the invention, in normal operation,

FIG. 4B illustrates the operation of the alternator according to the invention on strong load reductions,

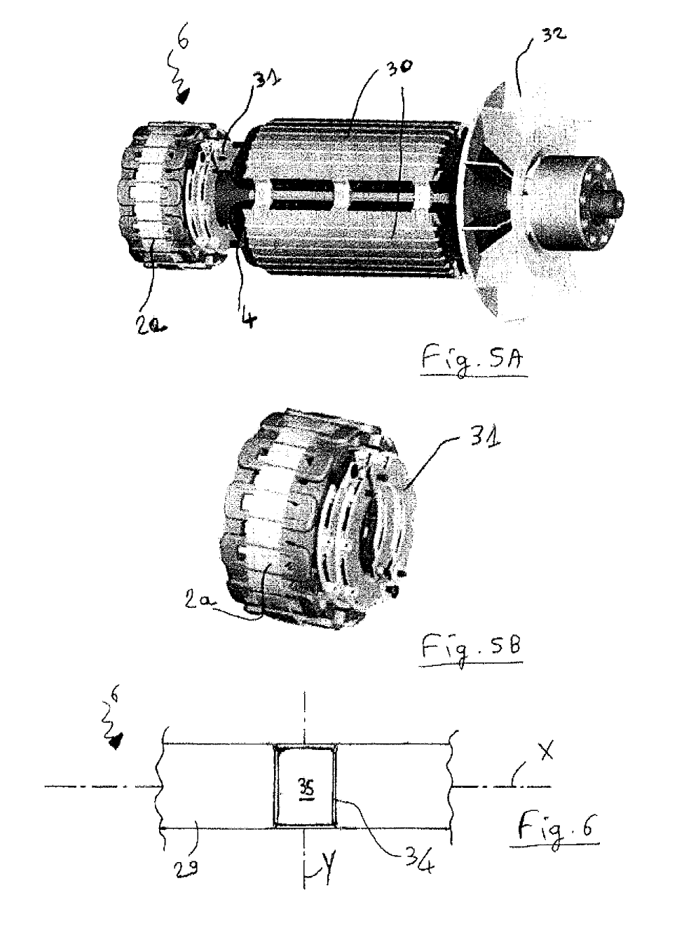

FIG. 5A represents an exemplary rotor according to the invention,

FIG. 5B is an enlarged view of certain elements of the rotor of FIG. 5A, and

FIG. 6 is an enlarged view of another exemplary rotor according to the invention.

An alternator according to the prior art, as illustrated in FIG. 1, is linked to a load 8, and includes a coiled exciting generator 2a, 2b, outputting to a rectifier 3 consisting of a dual-alternation diode bridge, and a primary machine 4, 5.

The rectified voltage of the exciting armature 2a is used to power the rotary field 4 of the primary machine. The voltage is controlled by a voltage regulator 7, powered by a source 12 and supplying the exciting inductor 2b with the excitation current according to the output voltage of the primary machine 4, 5.

The alternator 1 according to the invention, represented in FIG. 2, comprises a rotor 6 and a stator 9, which can be linked to a load 8.

The rotor 6 comprises a rotary field 4 and an exciting armature 2a. The rotor 6 includes a rectifier 3, consisting of a dual-alternation diode bridge, powering, from the exciting armature 2a, a DC bus 26 to which a switching system 11 is linked.

The DC bus 26 includes, in the example described, a filtering capacitor 21, the capacitance of which is, for example, less than 30 μF/kW of excitation power.

In a variant that is not represented, the DC bus 26 is unfiltered.

The rotor 6 includes a dissipative component 20, which is purely ohmic in the example described.

The switching system 11, which may be made up, as illustrated, of three switchable electronic components 22, 23, 24, for example IGBT transistors, and of two diodes 27 and 28, makes it possible to selectively link the rotary field 4 to the exciting armature 2a or to the dissipative component 20. In the example illustrated in FIG. 2, the switching system 11 comprises a dual-quadrant H-configuration bridge consisting of the diodes 27, 28 and of the switchable electronic components 22 and 24, outputting to the rotary field 4.

The alternator 1 also includes a controller 13 controlling the switching system 11, so as to regulate the current Iᵣₚ, in the rotary field 4 by pulse width modulation. The duty cycle a of the pulse width modulation is a function of the output voltage of the primary machine, so as to maintain the voltage delivered by the alternator, as far as possible, at a predefined value.

In the example described, the controller 13 is incorporated in the rotor 6 and revolves with the latter. In a variant that is not represented, the controller 13 is not incorporated in the rotor 6, being, for example, arranged in a remote cabinet or attached to the stator.

The controller 13 may comprise at least one integrated circuit.

The rotor 6 includes, in the example illustrated, a current sensor 10 for measuring the current Iᵣₚ in the rotary field 4. The duly measured value of the current is transmitted to the controller 13. The current sensor 10 may be a Hall effect sensor, but the invention is not limited to a particular type of current sensor.

The temperature sensor 25 of the rotary field 4 can be arranged on the rotor 1, as illustrated. The duly measured value of the temperature Tᵣₚ is transmitted to the controller 13.

The alternator 1 includes, on the stator 9, as illustrated in FIG. 3, an exciting inductor 2b and the armature 5 of the primary machine, linked to the load 8. The stator 9 is powered by a power supply 12.

The exciting inductor 2b is coiled, in the example described, In a variant that is not represented, the exciting inductor 2b comprises permanent magnets.

The stator 9 includes a voltage regulator 16, which can be seen in FIG. 3, consisting of a voltage regulation module 17 and a DC current generator 18.

In the variant, not illustrated, in which the exciting inductor 2b comprises permanent magnets, the voltage regulator 16 consists only of a voltage regulation module 17.

An RF wireless transmission system is arranged between the controller 13 of the rotor 6 and the voltage regulator 16 of the stator 9 of the alternator 1. The wireless transmission system is made up of a transmission module 14 arranged on the rotor 6, a transmission module 19 arranged on the stator 9, and wireless transmission channels 15 linking said modules.

The data exchanged between the transmission modules 14 and 15 are digital and, for example, coded on three bytes, or 24 bits.

The value of the current Iᵣₚ in the rotary field 4, measured by the current sensor 10 of the rotor 6, is transmitted to the voltage regulator 16 of the stator 9 by the wireless transmission system 14, 15, 19,

The value Tᵣₚ of the temperature of the rotary field 4, measured by the temperature sensor 25 situated on the rotor 6, is transmitted by the wireless transmission system 14, 15, 19 to the voltage regulator 16 situated on the stator 9.

The transmission module 14 and the controller 13 of the rotor 6 are powered by tapping a portion of the energy of the voltage of the exciting armature 2a rectified by the rectifier 3.

During the starting-up of the alternator 1, a control device, not represented, initializes all the electronic components and ensures a gradual increase in the output voltage of the primary machine.

In normal operation of the alternator 1, illustrated in FIG. 4A, that is to say in the absence of any reduction in the load 8, the voltage output from the rectifier 3 powers the rotary field 4, and the current circulates in the switchable electronic component 24, as illustrated. The switchable electronic component 22 is in passing mode, whereas the switchable electronic component 23 is blocked. The dissipative component 20 and the filtering capacitor 21 are not linked to the rotary field 4.

In this mode of operation or in the case of an application of load, the control of the switching system 11 by the controller 13 makes it possible to regulate the output voltage of the alternator 1 around a setpoint value by adjusting the duty cycle of the current powering the rotary field.

In the case of a reduction in the load 8, illustrated in FIG. 4B, the controller 13 reduces the duty cycle a according to the output voltage of the alternator. When the duty cycle a becomes zero, the switchable electronic component 22 is blocked, and the switchable electronic component 23 is in passing mode. In this phase, the voltage at the terminals of the rotary field 4 is reversed, making it possible to reduce the current Iᵣₚ in the rotary field as quickly as possible and avoiding significant voltage overshoots at the terminals of the alternator 1.

The controller 13 thus links the dissipative component 20 to the rotary field 4, to dissipate inductive energy stored in said rotary field. The inductive energy is dissipated in the form of heat in the dissipative component 20, and a portion of this energy is stored in the capacitor 21.

The connection of the dissipative component 20 to the rotary field 4 is established when the duty cycle a of the pulse width modulation controlling the switchable electronic component 24 is zero, and ceases when this duty cycle a becomes non-zero again.

The wireless transmission module 14 receives the switching commands from the switchable electronic component 24 in binary form, for example. This information is sent to the controller 13 which generates the pulse width modulation for the switching system 11.

The rotary field 4 can comprise four poles 30 and a ventilation element 32, as represented in FIG. 5A.

The rectifier 3, the switching system 11 and the controller 13 can be mounted on segments 31 fixed to an axial end of the exciting armature 2a. The segments 31 are crescent-shaped in the example of FIGS. 5A and 5B. The segments 31 can also have a heat-dissipating role.

In a variant, the rectifier 3, the switching system 11 and the controller 13 are mounted on modules fixed directly in one or more housings produced on the shaft 29 of the rotor 6, notably through insulating supports. For example, a tapped housing 34 of axis Y at right angles to the axis of rotation X of the rotor 6 is produced through the shaft, as represented in FIG. 6, and receives a module 35, As a variant, housings with equal angular distribution are used.

The invention is not limited to the examples which have just been described.

The expression “comprising a” should be understood to be synonymous with “comprising at least one”, unless otherwise specified.

1. Alternator to be electrically linked to a load, the alternator comprising:
a rotor comprising:
a rotary field of a primary machine,
an exciting armature
a dissipative component, and
a switching system making it possible to selectively link the rotary field to the exciting armature and to the dissipative component, and
a controller controlling the switching system so as to regulate current in the rotary field by pulse width modulation and, in response to a reduction in the load applied to the alternator, link the dissipative component to the rotary field to dissipate inductive energy stored in the rotary field, the duty cycle and the pulse width modulation being a function of the output voltage of the primary machine.

2. Alternator according to claim 1, the duty cycle of the pulse width modulation being a function of the current in the rotary field.

3. Alternator according to claim 1, the dissipative component being purely ohmic.

4. Alternator according to claim 1, the controller being incorporated in the rotor.

5. Alternator according to claim 1, the rotor including a rectifier supplying, from the exciting armature a DC bus to which the switching system is linked.

6. Alternator according to claim 5, the DC bus including a filtering capacitor.

7. Alternator according to claim 1, the DC bus being non-filtered.

8. Alternator according to claim 1, the switching system including an H-configuration bridge outputting the rotary field.

9. Alternator according to claim 1, the power for the transmission module and the controller of the rotor being supplied from the exciting armature voltage rectified by the rectifier.

10. Alternator according to claim 1, controller, controlling the switching system, comprising at least one integrated circuit.

11. Alternator according to claim 1, the rectifier, the switching system and the controller being mounted on segments.

12. Alternator according to claim 1, the rectifier, the switching system and the controller being mounted on one or more modules fixed directly onto the rotor, notably through one or more insulating supports.

13. Alternator according to claim 1, including a current sensor for measuring the current in the rotary field and for transmitting to the controller and/or to a voltage regulator the value of the duly measured current.

14. Alternator according to claim 1, including an exciting inductor comprising permanent magnets.

15 . Alternator according to claim 4, including a coiled exciting inductor.

16. Alternator according to claim 4, including a system for wireless transmission between controller and a voltage regulator at the stator of the alternator.

17. Alternator according to claim 16, including a temperature sensor for the rotary field, the measured value being transmitted by the wireless transmission system to the voltage regulator to the stator.

18. Alternator according to claim 17, the duty cycle of the pulse width modulation being a function of the temperature of the rotary field.

19. Alternator according to claim 1, the connection of the dissipative component to the rotary field being established when the duty cycle of the pulse width modulation is zero and ceasing when this duty cycle becomes non-zero again.

20. Method for reducing the load shedding response time of an alternator according to claim 1, in which:
in response to the detection of a reduction in the load applied to the alternator, the controller acts by pulse width modulation on the switching system to link the rotary field to the dissipative component, in order to dissipate inductive energy stored in the rotary field,
the duty cycle of the pulse width modulation being a function of the output voltage of the primary machine,

21. Method according to claim 20, in which, in response to the detection of a reduction in the load applied to the alternator, the voltage at the terminals of the rotary field is reversed, reducing the current in said rotary field.

22. Method for reducing the load impact response time of an alternator according to claim 1, in which:
in response to the detection of an increase in the load applied to the alternator, the controller acts by pulse width modulation on the switching system by adjusting the duty cycle of the pulse width modulation in order to increase the current in the rotary field and to reduce the voltage drop,
the duty cycle of the pulse width modulation being a function of the output voltage of the primary machine.
